(19) United States
(12) Patent Application Publication
(10) Pub. No.: US 2023/0179594 A1
(43) Pub. Date: Jun. 8, 2023

(54) ENHANCED BIOMETRIC AUTHORIZATION

(71) Applicant: Ford Global Technologies, LLC, Dearborn, MI (US)

(72) Inventors: John Robert Van Wiemeersch, Novi, MI (US); Ali Hassani, Ann Arbor, MI (US); Justin Miller, Berkley, MI (US); Jake Schwartz, Dearborn, MI (US)

(73) Assignee: Ford Global Technologies, LLC, Dearborn, MI (US)

(21) Appl. No.: 17/540,432

(22) Filed: Dec. 2, 2021

(51) Int. Cl. H04W 12/63

(52) U.S. Cl. CPC H04L 63/0861; H04L 63/107; H04W 12/63

(57) ABSTRACT

Upon detecting an authorized portable device, a user of the portable device is authenticated for a structure based on then receiving an authentication message from the authorized portable device. A location of the user is determined with respect to the structure. Instructions are provided to the authorized portable device for the user to provide biometric data based on the location. Upon obtaining the biometric data for the user, user data is generated for the user. Structure components are controlled based on the user data.

### BACKGROUND

A computer performing biometric authorization can receive sensor data to determine an identity of a person seeking authorization for access to be granted by the computer. Biometric authorization can include, for example, facial recognition, a type of biometric authorization where an image of a human face is used to identify a person. Biometric authorization can rely upon acquiring accurate biometric data.

### BRIEF DESCRIPTION OF THE DRAWINGS

FIG. 1 is a block diagram illustrating an example control system for a vehicle.

FIG. 2 is a diagram illustrating an exemplary passenger cabin of the vehicle.

FIG. 3A is a block diagram illustrating an example request message.

FIG. 3B is a block diagram illustrating an example authentication message.

FIG. 3C is a block diagram illustrating an example authorization message.

FIG. 3D is a block diagram illustrating an example response message.

FIG. 3E is a block diagram illustrating an example verification message.

FIG. 3F is a block diagram illustrating an example confirmation message.

FIGS. 4A-4C are diagrams illustrating an example authorized portable device providing instructions for a user to provide biometric data.

FIG. 5 is a flowchart of an example process for biometrically authorizing a user in a vehicle computer.

FIG. 6 is a flowchart of an example process for providing instructions in a portable device.

### DETAILED DESCRIPTION

Biometric authorization can be used by a computer to control access to devices, objects, and/or applications, e.g., to vehicles, buildings, computers, cell phones, other devices, etc. For example, biometric authorization can be implemented to permit authorized people to access, e.g., to a vehicle or building, and to deny access to unauthorized people. Biometric authorization may require that a user provide one or more types of biometric data and/or to provide the biometric data in a specific manner, e.g., in a specified sequence, to a specified sensor, etc., to generate user data that can be used to determine authorization. Biometric data is data representing measurements of physiological characteristics. A type of biometric data is data representing a specific physiological characteristic, e.g., distances between ridges in a fingerprint, distances between facial features, etc. Biometric authorization can authorize users by comparing the biometric data provided by the user to biometric data subsequently obtained via sensors in the vehicle, building, computing device, etc.

The results of performing the biometric authorization can be downloaded to a device granting or denying authorization and permission to access a structure, for example, a vehicle, a building, a room, a gated area, etc. Successful authorization can be used for security applications such as access to a location, e.g., a passenger cabin of a vehicle, a room, a building, etc., by unlocking a door. In other examples, successful authorization can be used to enable vehicle or building controls, or yet further alternatively or additionally access to a device such as a computer by enabling input devices, like a keyboard or mouse, or granting access to computer files.

Authorizing users for vehicles will be described herein as a non-limiting example of biometric authorization. That is, a vehicle will be described herein as a non-limiting example of a structure. It is to be understood that other types of structure, e.g., a building, a garage, a gated area, etc., could utilize the techniques described herein for biometric authorization.

Vehicles can be equipped with computing devices, networks, sensors, and controllers to acquire and/or process data regarding the environment and to permit access to the vehicle based on the data. For example, a camera in a vehicle can be programmed to acquire an image of an approaching user and, upon determining the identity of the user based on biometric authorization, e.g., via facial recognition software, unlock a door to permit the user to enter a passenger cabin of the vehicle. Likewise, cameras included in the passenger cabin of the vehicle can acquire one or more images of a user and, upon determining the identity of the user based on biometric authorization, e.g., via facial recognition software, accept commands from the user to operate the vehicle.

However, due to packaging constraints, multiple locations around the vehicle and/or in the passenger cabin may lack output devices that can provide instructions to the user to provide the requested biometric data. Advantageously, the vehicle computer can determine a user's location relative to the vehicle and then can provide, to an authorized portable device, instructions to provide requested biometric data. Providing the instructions to the authorized portable device allows the user to receive the instructions regardless of a presence or absence of an output device at the user's location, which can reduce an amount of time and computational resources required to obtain biometric data for the user and perform biometric authorization by reducing a likelihood of the user providing undesired biometric data.

A system includes a computer including a processor and a memory, the memory storing instructions executable by the processor to, upon detecting an authorized portable device, authenticate a user of the portable device for a structure based on then receiving an authentication message from the authorized portable device. The instructions further include instructions to determine a location of the user with respect to the structure. The instructions further include instructions to provide, to the authorized portable device, instructions for the user to provide biometric data based on the location. The instructions further include instructions to, upon obtaining the biometric data for the user, generate user data for the user. The instructions further include instructions to control structure components based on the user data.

The instructions can further include instructions to determine the location based on a user input.

The instructions can further include instructions to determine the location based on a location of the authorized portable device.

The instructions can further include instructions to determine the location based on data from sensors on the structure.

The instructions can further include instructions to obtain the biometric data from a sensor on the structure positioned to face the location.

The structure may be a vehicle. The instructions can further include instructions to operate the vehicle to satisfy an operating parameter specified by the user data.

The system may include the authorized portable device. The authorized portable device may include a second processor and a second memory, the second memory storing instructions executable by the second processor such that the authorized portable device is programmed to generate the authentication message based on a user input.

The system may include the authorized portable device. The authorized portable device may include a second processor and a second memory, the second memory storing instructions executable by the second processor such that the authorized portable device is programmed to, upon receiving the instructions, actuate one of a display or a speaker to output the instructions to the user to provide the biometric data.

The instructions can further include instructions to, upon generating the user data, provide, to the authorized portable device, a verification message to verify the user data.

The system may include the authorized portable device. The authorized portable device may include a second processor and a second memory, the second memory storing instructions executable by the second processor such that the authorized portable device is programmed to, upon receiving a user input verifying the user data, provide a confirmation message to the computer.

A method includes, upon detecting an authorized portable device, authenticating, at a computer, a user of the portable device for a structure based on then receiving an authentication message from the authorized portable device. The method further includes determining a location of the user with respect to the structure. The method further includes providing, to the authorized portable device, instructions for the user to provide biometric data based on the location. The method further includes, upon obtaining, at the computer, the biometric data for the user, generating user data for the user. The method further includes controlling structure components based on the user data.

The method can further include determining the location based on a user input.

The method can further include determining the location based on a location of the authorized portable device.

The method can further include determining the location based on data from sensors on the structure.

The method can further include obtaining the biometric data from a sensor on the structure positioned to face the location.

The structure may be a vehicle. The method can further include operating the vehicle to satisfy an operating parameter specified by the user data.

The method can further include generating, at the authorized portable device, the authentication message based on a user input

The method can further include, upon receiving the instructions, actuating, at the authorized portable device, one of a display or a speaker to output the instructions to the user to provide the biometric data

The method can further include, upon generating the user data, providing, to the authorized portable device, a verification message to verify the user data.

The method can further include, upon receiving a user input verifying the request, providing, at the authorized portable device, a confirmation message to the computer.

Further disclosed herein is a computing device programmed to execute any of the above method steps. Yet further disclosed herein is a computer program product, including a computer readable medium storing instructions executable by a computer processor, to execute an of the above method steps.

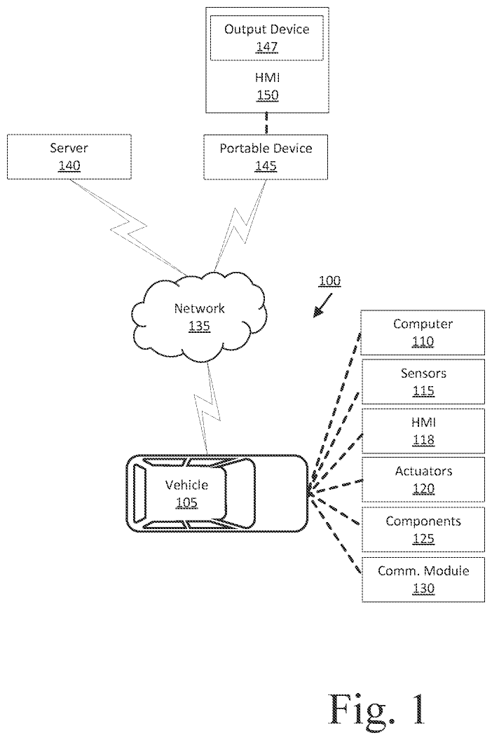

With reference to FIGS. 1-3F, an example control system 100 includes a vehicle 105. A vehicle computer 110 in the vehicle 105 receives data from sensors 115. The vehicle computer 110 is programmed to, upon detecting an authorized portable device 145, authenticate a user of the authorized portable device 145 for the vehicle 105 based on then receiving an authentication message 305 from the authorized portable device 145. The vehicle computer 110 is further programmed to determine a location of the user with respect to the vehicle 105. The vehicle computer 110 is further programmed to provide, to the authorized portable device 145, instructions for the user to provide biometric data based on the location. The vehicle computer 110 is further programmed to, upon obtaining the biometric data for the user, generate user data for the user. The vehicle computer 110 is further programmed to control vehicle components 125 based on the user data.

Turning now to FIG. 1, the vehicle 105 includes the vehicle computer 110, sensors 115, actuators 120 to actuate various vehicle components 125, and a vehicle 105 communication module 130. The communication module 130 allows the vehicle computer 110 to communicate with a remote server computer 140, and/or other vehicles, e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135.

The vehicle computer 110 includes a processor and a memory such as are known. The memory includes one or more forms of computer-readable media, and stores instructions executable by the vehicle computer 110 for performing various operations, including as disclosed herein. The vehicle computer 110 can further include two or more computing devices operating in concert to carry out vehicle 105 operations including as described herein. Further, the vehicle computer 110 can be a generic computer with a processor and memory as described above and/or may include a dedicated electronic circuit including an ASIC that is manufactured for a particular operation, e.g., an ASIC for processing sensor 115 data and/or communicating the sensor 115 data. In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in the vehicle computer 110.

The vehicle computer 110 may operate and/or monitor the vehicle 105 in an autonomous mode, a semi-autonomous mode, or a non-autonomous (or manual) mode, i.e., can control and/or monitor operation of the vehicle 105, including controlling and/or monitoring components 125. For purposes of this disclosure, an autonomous mode is defined as one in which each of vehicle 105 propulsion, braking, and steering are controlled by the vehicle computer 110; in a semi-autonomous mode the vehicle computer 110 controls one or two of vehicle 105 propulsion, braking, and steering; in a non-autonomous mode a human operator controls each of vehicle 105 propulsion, braking, and steering.

The vehicle computer 110 may include programming to operate one or more of vehicle 105 brakes, propulsion (e.g., control of acceleration in the vehicle 105 by controlling one or more of an internal combustion engine, electric motor, hybrid engine, etc.), steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to, e.g., via a vehicle communication network such as a communications bus as described further below, more than one processor, e.g., included in electronic controller units (ECUs) or the like included in the vehicle 105 for monitoring and/or controlling various vehicle components 125, e.g., a transmission controller, a brake controller, a steering controller, etc. The vehicle computer 110 is generally arranged for communications on a vehicle communication network that can include a bus in the vehicle 105 such as a controller area network (CAN) or the like, and/or other wired and/or wireless mechanisms.

Via the vehicle 105 network, the vehicle computer 110 may transmit messages to various devices in the vehicle 105 and/or receive messages (e.g., CAN messages) from the various devices, e.g., sensors 115, actuators 120, ECUs, etc. Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide data to the vehicle computer 110. For example, the sensors 115 may include Light Detection And Ranging (LIDAR) sensor 115(s), etc., disposed on a top of the vehicle 105, behind a vehicle 105 front windshield, around the vehicle 105, etc., that provide relative locations, sizes, and shapes of objects surrounding the vehicle 105. As another example, one or more radar sensors 115 fixed to vehicle 105 bumpers may provide data to provide locations of the objects, second vehicles, etc., relative to the location of the vehicle 105. The sensors 115 may further alternatively or additionally, for example, include camera sensor(s) 115, e.g., front view, side view, etc., providing images from an area surrounding the vehicle 105. As another example, the vehicle 105 can include one or more sensors 115, e.g., camera sensors 115, mounted inside a cabin of the vehicle 105 and oriented to capture images of users in the vehicle 105 cabin. In the context of this disclosure, an object is a physical, i.e., material, item that has mass and that can be represented by physical phenomena (e.g., light or other electromagnetic waves, or sound, etc.) detectable by sensors 115. Thus, the vehicle 105, as well as other items including as discussed below, fall within the definition of “object” herein.

The vehicle computer 110 is programmed to receive data from one or more sensors 115, e.g., substantially continuously, periodically, and/or when instructed by a remote server computer 140, etc. The data may, for example, include a location of the vehicle 105. Location data specifies a point or points on a ground surface and may be in a known form, e.g., geo-coordinates such as latitude and longitude coordinates obtained via a navigation system, as is known, that uses the Global Positioning System (GPS) and/or dead reckoning. Additionally, or alternatively, the data can include a location of an object, e.g., a vehicle 105, a sign, a tree, etc., relative to the vehicle 105. As one example, the data may be image data of the environment around the vehicle 105. In such an example, the image data may include one or more objects and/or markings, e.g., lane markings, on or along a road. As another example, the data may be image data of the vehicle 105 cabin, e.g., including users and seats in the vehicle 105 cabin Image data herein means digital image data, i.e., comprising pixels, typically with intensity and color values, that can be acquired by camera sensors 115. The sensors 115 can be mounted to any suitable location in or on the vehicle 105, e.g., on a vehicle 105 bumper, on a vehicle 105 roof, etc., to collect images of the environment around the vehicle 105.

The vehicle 105 actuators 120 are implemented via circuits, chips, or other electronic and or mechanical components that can actuate various vehicle 105 subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a brake component, a park assist component, an adaptive cruise control component, an adaptive steering component, one or more passive restraint systems (e.g., airbags), a movable seat, etc.

The vehicle 105 further includes a human-machine interface (HMI) 118. The HMI 118 includes user input devices such as knobs, buttons, switches, pedals, levers, touchscreens, and/or microphones, etc. The input devices may include sensors 115 to detect a user input and provide user input data to the vehicle computer 110. That is, the vehicle computer 110 may be programmed to receive user input from the HMI 118. The user may provide the user input via the HMI 118, e.g., by selecting a virtual button on a touchscreen display, by providing voice commands, etc. For example, a touchscreen display included in an HMI 118 may include sensors 115 to detect that a user selected a virtual button on the touchscreen display to, e.g., select or deselect an operation, which input can be received in the vehicle computer 110 and used to determine the selection of the user input.

The HMI 118 typically further includes output devices such as displays (including touchscreen displays), speakers, and/or lights, etc., that output signals or data to the user. The HMI 118 is coupled to the vehicle communication network and can send and/or receive messages to/from the vehicle computer 110 and other vehicle sub-systems.

In addition, the vehicle computer 110 may be configured for communicating via a vehicle-to-vehicle communication module or interface with devices outside of the vehicle 105, e.g., through a vehicle-to-vehicle (V2V) or vehicle-to-infrastructure (V2X) wireless communications (cellular and/or DSRC., etc.) to another vehicle, and/or to a remote server computer 140 (typically via direct radio frequency communications). The communication module could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module include cellular, Bluetooth, IEEE 802.11, Ultra-Wideband (UWB), Near Field Communication (NFC), dedicated short range communications (DSRC), and/or wide area networks (WAN), including the Internet, providing data communication services.

The network 135 represents one or more mechanisms by which a vehicle computer 110 may communicate with remote computing devices, e.g., the remote server computer 140, another vehicle computer, etc. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks 135 include wireless communication networks (e.g., using Bluetooth®, Bluetooth® Low Energy (BLE), UWB, NFC, IEEE 802.11, vehicle-to-vehicle (V2V) such as Dedicated Short Range Communications (DSRC), etc.), local area networks (LAN) and/or wide area networks (WAN), including the Internet, providing data communication services.

The remote server computer 140 can be a conventional computing device, i.e., including one or more processors and one or more memories, programmed to provide operations such as disclosed herein. Further, the remote server computer 140 can be accessed via the network 135, e.g., the Internet, a cellular network, and/or some other wide area network.

The portable device 145 can be a conventional computing device, i.e., including one or more processors and one or more memories, programmed to provide operations such as disclosed herein. The portable device 145 can be any one of a variety of computers that can be used while carried by a person, e.g., a smartphone, a tablet, a personal digital assistant, a smart watch, a key fob, etc. Further, the portable device 145 can be accessed via the network 135, e.g., the Internet, a cellular network, and/or or some other wide area network.

The portable device 145 includes one or more output devices 147 such as displays (including touchscreen displays), speakers, and/or lights, etc., that output signals or data to the user. For example, the portable device 145 may include an HMI 150 having the output device(s) 147. The HMI 150 of the portable device 145 has features in common with the HMI 118 of the vehicle computer 110, e.g., input devices and output devices, and therefore will not be described further to avoid redundancy.

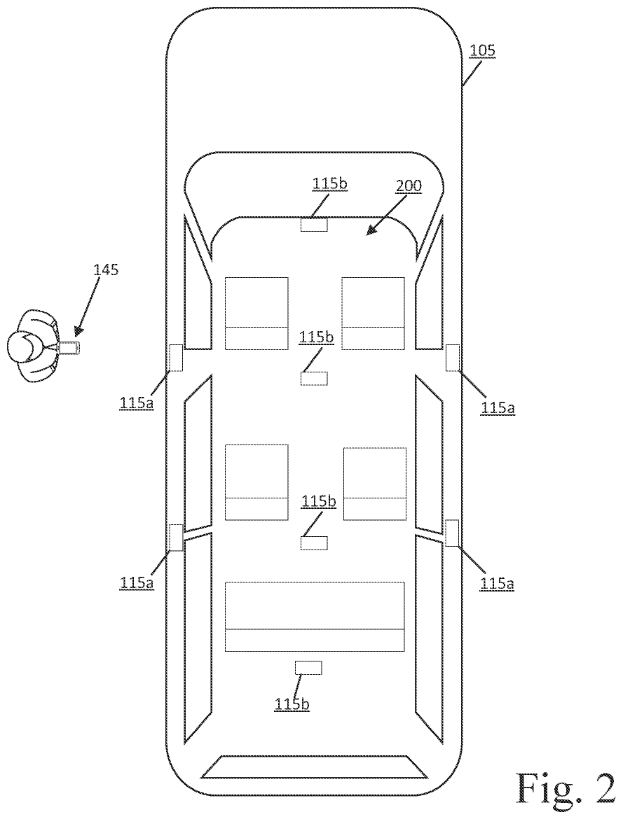

FIG. 2 is a diagram of a top view of an example passenger cabin 200 of an example vehicle 105. The vehicle 105 may include a body (not numbered) defining the passenger cabin 200 to house occupants, if any, of the vehicle. The body includes doors and windows that can be opened, e.g., to allow ingress and egress from the passenger cabin 200.

The passenger cabin 200 may extend across the vehicle 105, i.e., from one side to the other side of the vehicle 105. The passenger cabin 200 includes a front end (not numbered) and a rear end (not numbered) with the front end being in front of the rear end during forward movement of the vehicle 105. The passenger cabin 200 includes one or more seats (not numbered). The seats may be arranged in any suitable arrangement. For example, the passenger cabin 200 may include one or more front seats disposed at a front of the passenger cabin 200 and one or more back seats disposed behind the front seats. The passenger cabin 200 may also include third-row seats at the rear of the passenger cabin 200. In FIG. 2, the front seats and back seats are shown to be bucket seats and the third-row seats are shown to be bench seats, but the seats may be other types.

The vehicle 105 may include any suitable number of sensors 115, e.g., one or more. For example, as illustrated in FIG. 2, the vehicle 105 may include a plurality of external sensors 115a that are positioned to monitor an environment around the vehicle 105, and a plurality of internal sensors 115b that are positioned to monitor the passenger cabin 200 of the vehicle 105.

The vehicle computer 110 is programmed to detect a portable device 145 within a predetermined distance of the vehicle 105. For example, the vehicle computer 110 may be programmed to transmit, e.g., via a short-range broadcast protocol, a radio frequency (RF) signal, e.g., BLE, Ultra-Wideband (UWB), etc. The vehicle computer 110 can then detect the portable device 145 based on detecting either the return of the respective transmitted RF signal or a response RF signal transmitted from the portable device 145, e.g., continuously or in response to detecting the RF signal transmitted by the vehicle computer 110. Further, the vehicle computer 110 can determine a distance between the detected portable device 145 and the vehicle computer 110 based on the detected RF signal. For example, the vehicle computer 110 can determine the distance by using a time-of-flight measurement. For example, the vehicle computer 110 can calculate the distance based on an amount of time between transmission of the RF signal and detecting the return of the transmitted RF signal. Other non-limiting examples of techniques to determine the distance include RSSI (Receiver Signal Strength Indication), AoA (Angle of Arrival), Phase of the RF message, etc.

Upon detecting a portable device 145, the vehicle computer 110 can compare the distance between the portable device 145 and the vehicle computer 110 to the predetermined distance. The predetermined distance specifies a maximum distance from a vehicle 105 within which the vehicle computer 110 can identify a user. The predetermined distance may be determined empirically, e.g., based on testing that allows for determining a distance from the vehicle 105 that indicates the detected user is likely to seek access to the vehicle 105. The predetermined distance may be stored, e.g., in a memory of the vehicle computer 110.

If the distance is greater than the predetermined distance, then the vehicle computer 110 can ignore the detected portable device 145. If the distance is less than or equal to the predetermined distance, then the vehicle computer 110 can authorize the portable device 145, e.g., to prevent an unauthorized user from accessing and/or operating the vehicle 105. Authorizing the portable device 145 means the vehicle computer 110 determining that the portable device 145 has permission to communicate with the vehicle computer 110; a failure to authorize occurs upon a determination that the portable device 145 lacks permission to communicate with the vehicle computer 110. The vehicle computer 110 may be programmed to authorize the portable device 145 based on a key, e.g., a combination of numbers and/or characters, received from the portable device 145. For example, the vehicle computer 110 may authorize the portable device 145 based on determining the received key matches an expected key, e.g., known to certain parties such as vehicle 105 distributors, e.g., dealers, stored in the memory of the vehicle computer 110. As another example, the authorized portable device 145 can have an RFID device or the like uniquely specifying the user from among other potential users who regularly use the vehicle 105. The RFID signal can be associated with the user in memory, i.e., user data of the user includes the RFID signal. As another example, the authorized portable device 145 can pair with, e.g., the HMI 118. The authorized portable device 145 can be associated with the user in memory, i.e., user data of the user includes an identifier of the portable device 145.

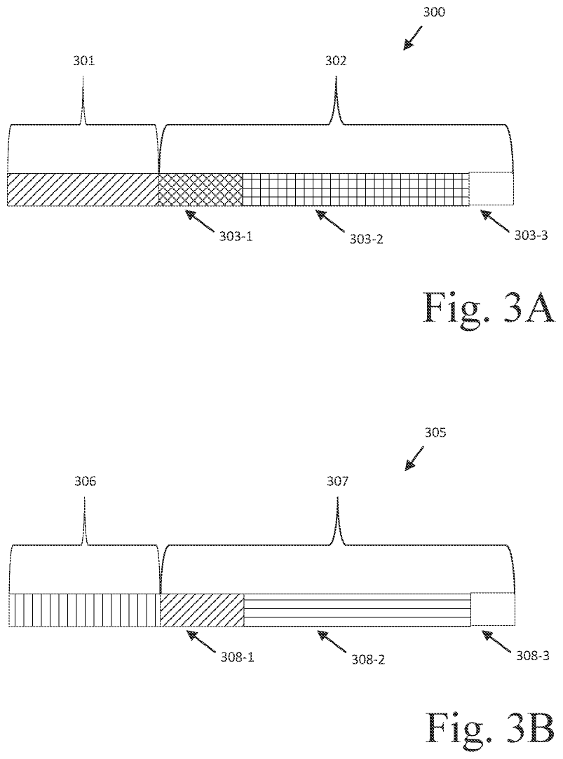

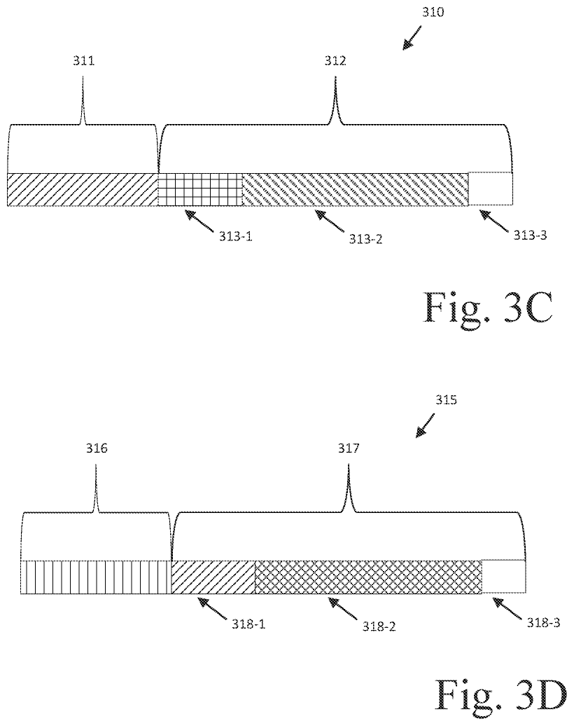

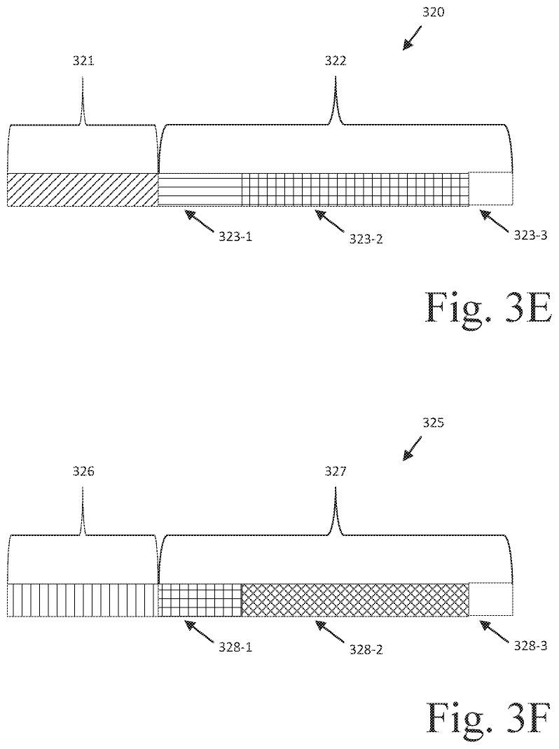

Upon authorizing the portable device 145, the vehicle computer can generate a request message 300. A request message includes a header 301 and a payload 302 (see FIG. 3A). The header 301 of the request message 300 may include a message type, a message size, etc. The payload 302 may include various data, i.e., message content. The payload 302 can include sub-payloads or payload segments 303-1, 303-2, 303-3 (collectively, referred to as payload segments 303). The respective payload segments 303 in FIG. 3A are illustrated as being of different lengths to reflect that different payload segments 303 may include various amounts of data, and therefore may be of different sizes, i.e., lengths. The payload 302 of the request message 300 includes, e.g., in a specified payload segment 303, a request to authenticate the user.

Upon generating the request message 300, the vehicle computer 110 can provide the request message 300 to the authorized portable device 145. For example, the vehicle computer 110 can transmit the request message 300 to the authorized portable device 145 via the network 135. The authorized portable device 145 can provide an authentication message 305 in response to the request message 300, as discussed below.

The vehicle computer 110 can authenticate the user based on the authentication message 305. Authenticating the user means validating or proving the identity of the user; a failure to authenticate occurs upon a determination that the user's identity cannot be validated proved. The vehicle computer 110 can monitor the network to detect the authentication message 305. Upon receiving the authentication message 305, the vehicle computer 110 can access a payload 307, e.g., a specified payload segment 308, of the authentication message 305 and retrieve identifying information about the user, e.g., a username and password. The vehicle computer 110 can compare the retrieved identifying information to identifying information stored, e.g., in a memory of the vehicle computer 110. If the retrieved identifying information matches the stored identifying information, then the vehicle computer 110 determines to authenticate the user. In this context, “match” means retrieved identifying information identifies a same user as stored identifying information. If the retrieved identifying information does not match the stored identifying information, then the vehicle computer 110 determines to not authenticate the user. In this situation, the vehicle computer 110 can control vehicle components 125 to prevent operation of the vehicle 105. Additionally, the vehicle computer 110 can control vehicle components 125, e.g., disabling virtual buttons on the HMI 118, to prevent the user from accessing and/or updating user data stored in the memory of the vehicle computer 110.

Upon authenticating the user, the vehicle computer 110 can query the memory to select the user data of the authenticated user. The vehicle computer 110 can control vehicle 105 operation based on the user data for the authenticated user. The vehicle computer 110 can store, e.g., in a memory, user data for each of a plurality of potential users. The user data can keep track of authorized users, i.e., users that have permission to access the vehicle 105, and the user data can be updated over time as biometric data for the user changes, e.g., due to weight gain or loss, age, hair growth or loss, etc. User data includes biometric data for the respective user and a user authorization for the respective user. A user authorization, as used herein, specifies one or more vehicle 105 features that a user has permission to access and/or one or more operating parameters that a user has permission to control.

In the context of this document a “vehicle feature” is a setting of a vehicle component 125 that can be selected by user input, e.g., via the HMI 118. Non-limiting examples of vehicle 105 features include seat configurations, mirror positions, heating and/or cooling seats, climate control, e.g., in multiple zones or areas of the passenger cabin 200, heating a steering wheel, auto-dimming a rearview mirror, heating side mirrors, multi-color lighting, controlling a radio, controlling a moonroof, etc.

In the context of this document an “operating parameter” is an actual value of a measurement of a physical characteristic of a vehicle 105 or an environment around that vehicle 105 during vehicle operation. A variety of operating parameters may be determined during vehicle 105 operation. A non-limiting list of operating parameters includes a speed of the vehicle 105, a following distance between vehicles, a stopping location, an acceleration rate of the vehicle 105, a vehicle 105 destination, a vehicle 105 route, etc.

In an example in which the structure is a building, the user authorization may specify the building, or a room therein, that a user is permitted or prevented from entering. Additionally, or alternatively, the user authorization may specify one or more controls for the building that the user is permitted or prevented from controlling, e.g., light controls, heating controls, cooling controls, speaker controls, etc.

When no user data is associated with the authenticated user, the vehicle computer 110 can be programmed to initiate biometric enrollment for the authenticated user based on the authentication message 305. For example, the vehicle computer 110 can access the payload 307, e.g., a specified payload segment 308, of the authentication message 305 and retrieve data specifying to initiate biometric enrollment or biometric authorization (as discussed below). That is, in addition to authenticating the user, the vehicle computer 110 can initiate biometric enrollment (and/or biometric authorization) in response to receiving the authentication message 305. Biometric enrollment in this document means generating user data based on obtaining initial, i.e., baseline, biometric data for a given user. That is, biometric data obtained prior to the generation of user data for a user may be referred to as enrollment biometric data.

When user data is associated with the authenticated user, the vehicle computer 110 is programmed to biometrically authorize the user based on challenge biometric data, as discussed below. That is, biometric data obtained subsequent to the generation of the user data for the user may be referred to as challenge biometric data.

To obtain biometric data, the vehicle computer 110 is programmed to determine a location of the user relative to the vehicle 105. For example, the user may be located external to or internal to the passenger cabin 200. Additionally, or alternatively, the user may be located adjacent to a door of the vehicle 105, e.g., in a driver seat, in a rear seat, standing outside the passenger cabin 200 (see FIG. 2) and adjacent to a pillar of the vehicle 105, etc.

The vehicle computer 110 may receive the user's location from the authorized portable device 145. For example, the authorized portable device 145 may include the location of the user in the authentication message 305. In such an example, the vehicle computer 110 can access a payload 307, e.g., a specified payload segment 308, of the authentication message 305 and retrieve the location of the user.

As another example, the authorized portable device 145 can provide a first user input specifying the user's location. In such an example, the authorized portable device 145 can actuate the HMI 150 to display virtual buttons corresponding to respective locations within the passenger cabin 200, e.g., driver seat, passenger seat, rear seat, etc., that the user can select to specify the location. In other words, the HMI 150 may activate sensors that can detect the user selecting a virtual button to specify the user's location. Upon detecting the user input, the authorized portable device 145 can provide the first user input to the vehicle computer 110, e.g., by transmitting the first user input via the network 135, and the vehicle computer 110 can determine the location of the user based on the first user input.

Additionally, or alternatively, the vehicle computer 110 can detect the user via sensor 115 data. For example, the vehicle computer 110 can determine the location of the user based on the user being detected in field(s) of view of one or more sensors 115, e.g., internal sensors 115b and/or external sensors 115a. For example, the vehicle computer 110 can determine the user is outside of the passenger cabin 200 and adjacent to a driver's door based on data from an external sensor 115a, as shown in FIG. 2. The fields of view of the sensors 115 may be stored, e.g., in a memory of the vehicle computer 110. As another example, the vehicle computer 110 can determine the location of the user based on detecting, via a door sensor 115, a door of the vehicle 105 is opened.

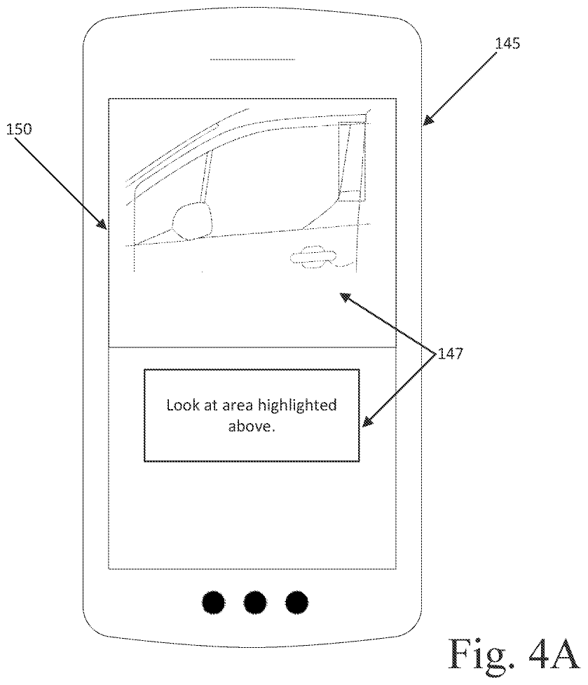

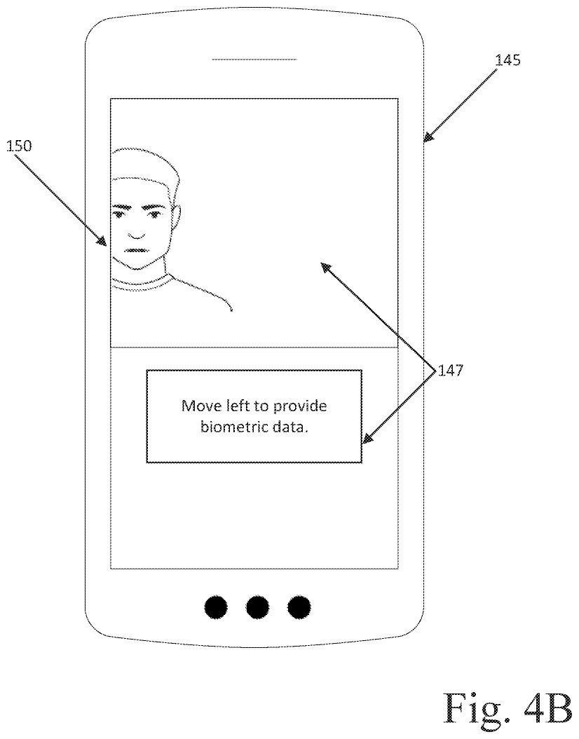

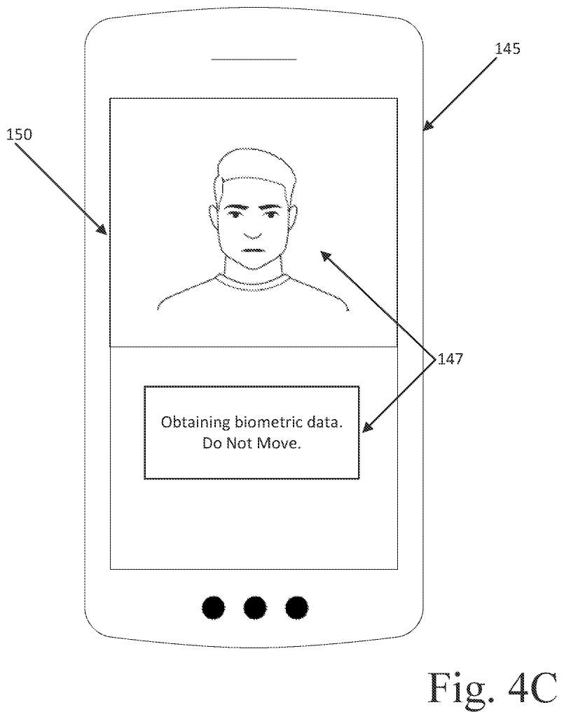

Upon determining the location of the user, the vehicle computer 110 is programmed to determine instructions specifying actions for the user to perform, e.g., to interact with, such as face and/or touch, a specified sensor, to adjust a user pose relative to a specified sensor, to remove accessories, such as hats, glasses, etc., to speak a word or phrase, etc., to allow the vehicle computer 110 to obtain biometric data for the user. The instructions specify users to interact with different sensors 115 based on the user's location. For example, the instructions may specify users in different seats to interact with different sensors 115. Additionally, the instructions may specify users external to the passenger cabin 200 interact with external sensors 115a (see FIG. 4A), and users internal to the passenger cabin interact with internal sensors 115b. The vehicle computer 110 may maintain a look-up table, or the like, that associates various instructions with corresponding user locations. The look-up table may be stored, e.g., in a memory of the vehicle computer 110. The vehicle computer 110 can determine the instructions using the look-up table by selecting the instructions associated with the stored user location that matches the determined user location.

Upon determining the instructions, the vehicle computer 110 can provide the instructions to the authorized portable device 145, e.g., in substantially the same manner as discussed above regarding providing the request message 300. Additionally, or alternatively, the vehicle computer 110 can provide the instructions to the HMI 118 in the vehicle 105. In this example, the HMI 118 can actuate one or more output devices, such as a display, a speaker, etc., to output the instructions to the user.

Upon providing the instructions, the vehicle computer 110 can actuate one or more sensors 115 based on the user's location. Specifically, the vehicle computer 110 can actuate the sensor(s) 115 positioned to face the user's location. For example, the vehicle computer 110 can actuate sensors 115 to detect the user at the location. In such an example, the vehicle computer 110 can be programmed to verify the user's location prior to obtaining biometric data for the user. For example, the instructions can include an instruction to perform a gesture, i.e., a specified movement by the user, e.g., waving a hand, giving a thumbs up, etc., while facing a specified sensor 115. The vehicle computer 110 can verify the location of the user based on detecting the gesture via sensor 115 data. In this situation, the vehicle computer 110 can obtain sensor 115 data of the location of the user prior to obtaining biometric data for the user. The vehicle computer 110 can analyze the sensor 115 data, e.g., using known gesture recognition techniques, to determine whether the user is performing the gesture specified by the instructions at the location. If the vehicle computer 110 determines that the user is performing the gesture, then the vehicle computer 110 can verify the user's location. If the vehicle computer 110 determines that the user is not performing the gesture, then the vehicle computer 110 can determine to not verify the user's location. In this situation, the vehicle computer 110 can send a message to the authorized portable device 145 indicating that biometric authorization cannot be performed until the user's location is verified.

Additionally, or alternatively, the vehicle computer 110 can determine whether to provide updated instructions specifying updated actions for the user to perform to allow the vehicle computer 110 to obtain the biometric data for the user. That is, the vehicle computer 110 may determine that the current user action does not allow the vehicle to obtain biometric data for the user. The vehicle computer 110 can, for example, analyze image data including the user, e.g., using known image processing techniques, to determine a pose of the user relative to an image sensor 115. In this situation, the vehicle computer 110 can determine whether to instruct the user to move relative to the image sensor 115 (see FIG. 4B), e.g., to a specified position with respect to a field of view of the image sensor 115. As another example, the vehicle computer 110 can analyze a fingerprint, e.g., using known data processing techniques, to determine whether to instruct the user to touch a different location relative to a capacitive touch sensor 115. In this situation, the vehicle computer 110 can determine whether to instruct the user to touch a different location move relative to the capacitive touch sensor 115. Upon determining that the current user action allows for the vehicle computer 110 to obtain the biometric data for the user, the vehicle computer 110 can provide updated instructions specifying the user to not move while the biometric data is obtained (see FIG. 4C). The vehicle computer 110 can provide the updated instructions to the authorized portable device 145, e.g., as discussed above.

Upon providing the instructions and/or determining that the current user action allows the vehicle computer 110 to obtain biometric data for the user, the vehicle computer 110 can actuate the sensor(s) 115 to obtain the biometric data for the user. The vehicle computer 110 can actuate various sensors 115 to obtain corresponding types of biometric data. For example, the vehicle computer 110 can actuate an image sensor 115 to obtain image data including facial characteristics of the user. Additionally, or alternatively, the vehicle computer 110 can actuate a capacitive touch sensor 115 to obtain data including a fingerprint of the user.

During biometric enrollment, the vehicle computer 110 generates user data for the authenticated user. For example, the vehicle computer 110 can maintain a look-up table or the like, e.g., stored in the memory of the vehicle computer 110, that associates the authenticated user with the corresponding biometric data. Upon determining to initiate biometric enrollment, the vehicle computer 110 can update the look-up table to associate the identified user with the enrollment biometric data.

Additionally, the vehicle computer 110 can generate an authorization message 310. Similar to the request message 300, the authorization message 310 includes a header 311 and a payload 312, including payload segments 313 (see FIG. 3C). The header 311 of the authorization message 310 may include a message type, a message size, etc. The payload 312, e.g., in a specified payload segment 313, includes a request for a second user input that specifies user authorization. The vehicle computer 110 can then provide the authorization message 310 to the authorized portable device 145, e.g., as discussed above regarding providing the request message 300. The authorized portable device 145 can provide a response message 315 in response to the authorization message 310, as discussed below.

Upon receiving the response message 315, the vehicle computer 110 can determine the user authorization for the authenticated user. For example, the vehicle computer 110 can access the payload 317, e.g., a specified payload segment 318, and retrieve the user authorization, e.g., one or more vehicle 105 features and/or operating parameters the user has permission to access and/or adjust. The vehicle computer 110 can then update the user data to include the retrieved user authorization. That is, the user data can associate the user authorization with the corresponding user.

Upon generating the user data, the vehicle computer 110 can generate a verification message 320. Similar to the request message 300, the verification message 320 includes a header 321 and a payload 322, including payload segments 323 (see FIG. 3E). The header 321 of the verification message 320 may include a message type, a message size, etc. The payload 322, e.g., in a specified payload segment 323, may include a request to verify the user data for the user. Verifying the user data means confirming that the user data is associated with an authorized user; a failure to verify occurs upon a determination that the user data is not associated with an authorized user. The vehicle computer 110 can then provide the verification message 320 to the authorized portable device 145, e.g., as discussed above regarding providing the request message 300. The authorized portable device 145 may provide a confirmation message 325 in response to the verification message 320, as discussed below.

The vehicle computer 110 may be programmed to initiate a timer upon providing the verification message 320 to the authorized portable device 145. A duration of the timer may be a predetermined amount of time, e.g., determined empirically based on testing that allows for determining an average amount of time for various users to respond to messages received via corresponding authorized portable devices 145.

The vehicle computer 110 can receive the confirmation message 325 from the authorized portable device 145. For example, the vehicle computer 110 can monitor the network 135 to detect the confirmation message 325 from the authorized portable device 145. If the vehicle computer 110 receives the confirmation message 325 prior to expiration of the timer, then the vehicle computer 110 can verify the user data for the user. If the vehicle computer 110 does not receive the confirmation message 325 prior to expiration of the timer, then the vehicle computer 110 can determine to not verify the user data for the user. In this situation, the vehicle computer 110 can be programmed to delete the user data. In such an example, the vehicle computer 110 may re-initiate biometric enrollment for the user. In other words, the vehicle computer 110 may provide instructions to the authorized portable device 145 for the user to provide biometric data, e.g., as discussed above.

As set forth above, upon identifying user data of the authenticated user, the vehicle computer 110 can authorize the authenticated user based on the challenge biometric data. That is, the vehicle computer 110 can perform biometric authorization using the challenge biometric data and the user data. Authorizing the authenticated user means determining that the authenticated user has permission to access the vehicle 105; a failure to authorize occurs upon a determination that the authenticated user lacks permission to access the vehicle 105.

Biometric facial recognition is described herein as one non-limiting example of biometric authorization. Biometric facial recognition typically operates by calculating physiological characteristics of a human face and comparing the calculated physiological characteristics to stored physiological characteristics from the trained model. Physiological characteristics can include measures of facial features such as the distance between pupils, distance between corners of the mouth and length of nose, etc. These measures can be normalized by forming ratios of the measurements and stored as the trained model. At challenge time, an image of the human seeking access is acquired and processed to extract physiological characteristics which are then compared to stored physiological characteristics to determine a match. Other non-limiting examples of biometric authorization can include fingerprint recognition, eye recognition, voice recognition, etc.

Biometric authorization software can be executed on the vehicle computer 110 or the sensor 115 data, e.g., image data, can be uploaded to a remote server computer 140 that maintains a database of trained models for execution. An example of biometric authorization software is facial identification software, for example Face Tracker. Face Tracker is a facial recognition software library written in C++ and available on facetracker.net under the MIT software license.

Facial identification software can determine two sets of facial features corresponding to a challenge image and an enrollment image and determine ratios of distances between features. Facial identification software can determine a confidence score by determining a match value with previously determined facial identification features. A user status can be determined by comparing the confidence score to a threshold. The threshold can be determined empirically, e.g., based on testing that allows for determining a threshold that minimizes a number of incorrectly authorized users.

Facial features include locations on a facial image such as inner and outer corners of the eyes and corners of the mouth. For example, facial feature detection routines such as SURF in the Dlib image processing library can determine locations on a face corresponding to facial features such as the center of each eye and the center of a mouth. The facial identification software can compare the ratios based on the two sets of features and determine a match value. If the ratios between sets of features match, meaning that they have the same value within an empirically determined tolerance, the person in the challenge image is determined to be the same person as in the previously acquired enrollment image.

The match value can be determined by determining a mean squared difference between the two sets of ratios. Matching the ratios of distances can reduce the variance in facial feature measurements caused by differences due to differences in distances from the camera and differences in poses between the two images.

The confidence score can be determined by multiplying the match value by a scalar constant that maps the match value to the interval (0,1), with values close to 1 corresponding to a good match and values close to 0 corresponding to a poor match. The scalar constant can be determined empirically by acquiring and testing a plurality of enrollment and challenge images.

A confidence score greater than a threshold can indicate that the challenge biometric data is a good match for the enrollment biometric data, therefore the user status should be “authorized.” A confidence score less than or equal to the threshold can indicate that the challenge biometric data did not match the enrollment biometric data, and therefore user status should be set to “not authorized.” A confidence score less than or equal to the threshold can indicate problems with the challenge biometric data, e.g., an unauthorized user passed facial identification, or an authorized user failed facial identification.

Upon determining that the user is authorized, the vehicle computer 110 can control the vehicle 105 based on the user data for the user, e.g., the user authorization. For example, the vehicle computer 110 can control vehicle 105 locks to permit the user to access areas of the vehicle 105, e.g., a driver seat, a passenger seat, a rear seat, etc., specified by the user authorization Additionally, the vehicle computer 110 can actuate one or more vehicle components 125 to operate the vehicle 105 to satisfy the operating parameters specified by the user authorization. As another example, the vehicle computer 110 can actuate one or more vehicle components 125 to adjust one or more vehicle 105 features specified by the user authorization.

Upon determining that the user is not authorized, the vehicle computer 110 can control vehicle 105 locks to prevent the user from accessing the vehicle 105, e.g., the passenger cabin 200. Additionally, or alternatively, the vehicle computer 110 can prevent actuation of one or more vehicle components 125, e.g., so as to prevent operation of the vehicle 105 and/or adjustment of one or more vehicle 105 features.

The authorized portable device 145 can receive the request message 300 from the vehicle computer 110. For example, the authorized portable device 145 can monitor the network 135 to detect the request message 300. Upon receiving the request message 300, the authorized portable device 145 can then actuate the HMI 150 to detect a first user input. For example, the HMI 150 may actuate one or more sensors to detect the user selecting corresponding virtual buttons to provide identifying information such as a username and password. Additionally, the HMI 150 may actuate one or more sensors to detect the user selecting corresponding virtual buttons to initiate biometric enrollment or biometric authorization.

Upon detecting the first user input, the authorized portable device 145 can generate the authentication message 305 based on the first user input. Similar to the request message 300, the authentication message 305 includes a header 306 and a payload 307, including payload segments 308 (see FIG. 3B). The header 306 of the authentication message 305 may include a message type, a message size, etc. The payload 307, e.g., in a specified payload segment 308, includes the first user input. The authorized portable device 145 can then provide the authentication message 305 to the vehicle computer 110, e.g., as discussed above regarding providing the request message 300.

The authorized portable device 145 may be programmed to receive instructions (and updated instructions) from the vehicle computer 110. For example, the authorized portable device 145 can monitor the network 135 to detect the instructions (and updated instructions). Upon receiving the instructions (and updated instructions), the authorized portable device 145 can provide the instructions (and updated instructions) to the user. For example, the authorized portable device 145 can instruct the HMI 150 to actuate the output device(s) 147 to output the instructions (and the updated instructions) to the user (see FIGS. 4A-4C).

The authorized portable device 145 may be programmed to receive the authorization message 310 from the vehicle computer 110. For example, the authorized portable device 145 can monitor the network 135 to detect the authorization message 310. Upon receiving the authorization message 310, the authorized portable device 145 can actuate the HMI 150 to detect a second user input specifying the user authorizations. For example, the HMI 150 may be programmed to display virtual buttons representing respective vehicle 105 features and/or operating parameters that the user can select to specify the user authorizations. In other words, the HMI 150 may activate sensors that can detect the user selecting the virtual button(s) to select the user authorization(s).

Upon detecting the second user input, the authorized portable device 145 can generate a response message 315 based on the second user input. Similar to the request message 300, the response message 315 includes a header 316 and a payload 317, including payload segments 318 (see FIG. 3D). The header 316 of the response message 315 may include a message type, a message size, etc. The payload 317, e.g., in a specified payload segment 318, includes the second user input. The authorized portable device 145 can then provide the response message 315 to the vehicle computer 110, e.g., as discussed above regarding providing the request message 300.

The authorized portable device 145 may be programmed to receive the verification message 320 from the vehicle computer 110. For example, the authorized portable device 145 can monitor the network 135 to detect the verification message 320. Upon receiving the verification message 320, the authorized portable device 145 can actuate the HMI 150 to detect a third user input verifying the user data for the user. For example, the HMI 150 may be programmed to display a virtual button that the user can select to verify the user data. In other words, the HMI 150 may activate sensors that can detect the user selecting the virtual button to verify the user data.

Upon detecting the third user input, the authorized portable device 145 can generate a confirmation message 325. Similar to the request message 300, the confirmation message 325 includes a header 326 and a payload 327, including payload segments 328 (See FIG. 3F). The header 326 of the confirmation message 325 may include a message type, a message size, etc. The payload 327, e.g., in a specified payload segment 328, includes the third user input. The authorized portable device 145 can then provide the confirmation message 325 to the vehicle computer 110, e.g., in substantially the same manner as discussed above regarding providing the request message 300.

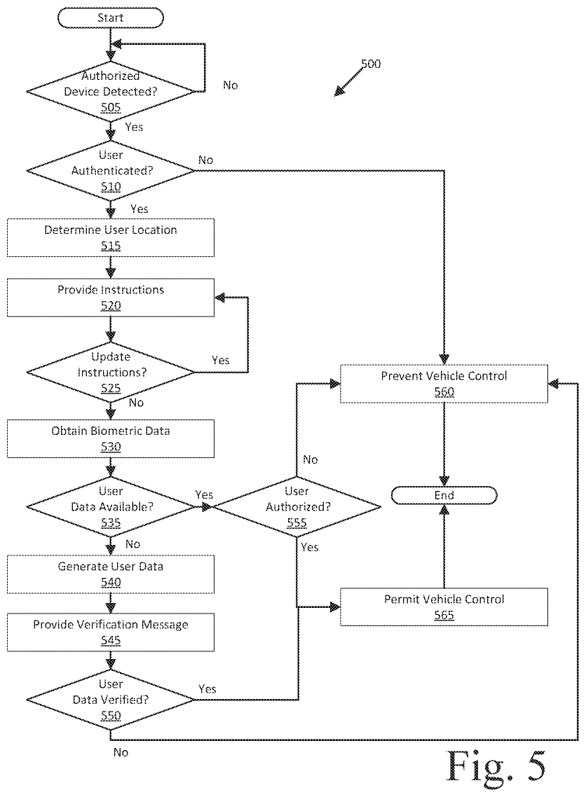

FIG. 5 is a diagram of an example process 500 executed in a vehicle computer 110 according to program instructions stored in a memory thereof for biometrically authorizing a user. Process 500 includes multiple blocks that can be executed in the illustrated order. Process 500 could alternatively or additionally include fewer blocks or can include the blocks executed in different orders.

Process 500 begins in a block 505. In the block 505, the vehicle computer 110 determines whether an authorized portable device 145 is detected. As set forth above, the vehicle computer 110 can detect a portable device 145, e.g., based on detecting the return of a transmitted RF signal. Upon determining that the portable device 145 is within a predetermined distance of the vehicle 105, the vehicle computer 110 can authorize the portable device 145, as discussed above. If the vehicle computer 110 authorizes the portable device 145, then the process 500 continues in a block 510. If the vehicle computer 110 determines to not authorize the portable device 145, or the portable device 145 is not within the predetermined distance of the vehicle 105, the process 500 remains in the block 505.

In the block 510, the vehicle computer 110 determines whether the user is authenticated. As set forth above, the vehicle computer 110 can generate and provide a request message 300 to the authorized portable device 145. Upon receiving an authentication message 305 from the authorized portable device 145, the vehicle computer 110 can compare identifying information retrieved from the authentication message 305 to stored identifying information for an authenticated user associated with the authorized portable device 145. If the retrieved identifying information matches the stored identifying information, then the process 500 continues in a block 515. Otherwise, the process 500 continues in a block 560.

In the block 515, the vehicle computer 110 determines a location of the user relative to the vehicle 105, as discussed above. The process 500 continues in a block 520.

In the block 520, the vehicle computer 110 provides instructions to the authorized portable device 145. The instructions specify actions for the user to provide biometric data based on the location of the user. The vehicle computer 110 can select the instructions based on the user's location, as discussed above. The process 500 continues in a block 525.

In the block 525, the vehicle computer 110 determines whether to provide updated instructions to the user, e.g., based on determining a current user action does not allow the vehicle computer 110 to obtain biometric data, as discussed above. The updated instructions specify updated actions for the user to provide biometric data based on the location of the user. If the vehicle computer 110 determines to provide updated instructions, then the process 500 returns to the block 520. Otherwise, the process 500 continues in a block 530.

In the block 530, the vehicle computer 110 actuates one or more sensors 115 to obtain biometric data for the user. As discussed above, the vehicle computer 110 can obtain one or more types of biometric data for the user. The process 500 continues in a block 535.

In the block 535, the vehicle computer 110 determines whether user data of the authenticated user is available, e.g., stored in a memory of the vehicle computer 110, as discussed above. If user data of the authenticated user is available, then the process 500 continues in a block 555. Otherwise, the process 500 continues in a block 540.

In the block 540, the vehicle computer 110 generates user data for the authenticated user. That is, the vehicle computer 110 associates the biometric data obtained in the block 530 with the authenticated user, as discussed above. Additionally, the vehicle computer 110 can generate and provide an authorization message 310 to the authorized portable device 145, as discussed above. Upon receiving a response message 315 from the authorized portable device 145, the vehicle computer 110 can associate one or more user authorizations with the authenticate user, as discussed above. The process 500 continues in a block 545.

In the block 545, the vehicle computer 110 generates and provides a verification message 320 to the authorized portable device 145, as discussed above. Additionally, the vehicle computer 110 may initiate a timer upon providing the verification message 320, as discussed above. The process 500 continues in the block 550.

In the block 550, the vehicle computer 110 determines whether to verify the user data. The vehicle computer 110 can receive a confirmation message 325 from the authorized portable device 145, as discussed above. If the vehicle computer 110 receives the confirmation message 325 from the authorized portable device 145 prior to expiration of the timer, then the vehicle computer 110 can verify the user data. If the vehicle computer 110 does not receive the confirmation message 325 from the authorized portable device 145 prior to expiration of the timer, then the vehicle computer 110 can determine to not verify the user data. If the user data is verified, the process 500 continues in a block 565. Otherwise, the process 500 continues in the block 560.

In the block 555, the vehicle computer 110 determines whether the authenticated user is authorized. That is, the vehicle computer 110 performs biometric authentication using the biometric data obtained in the block 530, as discussed above. If the vehicle computer 110 determines that the authenticated user is authorized, then the process 500 continues in the block 565. Otherwise, the process 500 continues in the block 560.

In the block 560, the vehicle computer 110 prevents the user from controlling and/or accessing the vehicle 105, as discussed above. The process 500 ends following the block 560.

In the block 565, the vehicle computer 110 controls one or more vehicle components 125 based on the user data for the user, as discussed above. The process 400 ends following the block 565.

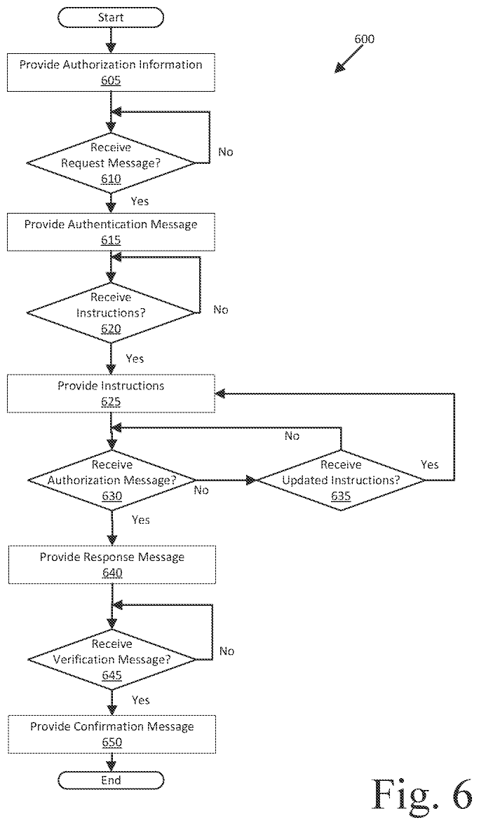

FIG. 6 is a diagram of an example process 600 executed in a portable device 145 according to program instructions stored in a memory thereof for providing instructions to provide biometric data based on a user's location relative to a vehicle 105. Process 600 includes multiple blocks that can be executed in the illustrated order. Process 600 could alternatively or additionally include fewer blocks or can include the blocks executed in different orders.

Process 600 begins in a block 605. In the block 605, the portable device 145 provides authorization information to the vehicle computer 110. That is, the portable device 145 can provide information to the vehicle computer 110 that the vehicle computer 110 can use to authorize the portable device 145, as discussed above. The process 600 continues in a block 610.

In the block 610, the authorized portable device 145 determines whether a request message 300 is received from the vehicle computer 110. The authorized portable device 145 can monitor the network 135 to detect the request message 300, as discussed above. If the request message 300 is received, then the process 600 continues in a block 615. Otherwise, the process 600 remains in the block 610.

In the block 615, the authorized portable device 145 generates and provides an authentication message 305 to the vehicle computer 110, as discussed above. The authorized portable device 145 can generate the authentication message 305 to include identifying information for the user, as discussed above. The authorized portable device 145 can determine the identifying information by actuating an HMI 150 to detect a first user input specifying the identifying information, as discussed above. Additionally, the first user input can specify to initiate biometric enrollment or biometric authorization, as discussed above. The process 600 continues in a block 620.

In the block 620, the authorized portable device 145 determines whether instructions are received from the vehicle computer 110. The authorized portable device 145 can monitor the network 135 to detect the instructions, as discussed above. The instructions specify actions for the user to provide biometric data based on the location of the user, as discussed above. If the instructions are received, then the process 600 continues in a block 625. Otherwise, the process 600 remains in the block 620.

In the block 625, the authorized portable device 145 actuates the output device(s) 147 to provide the instructions (or updated instructions) to the user. The process 600 continues in a block 630.

In the block 630, the authorized portable device 145 determines whether an authorization message 310 is received from the vehicle computer 110. The authorized portable device 145 can monitor the network 135 to detect the authorization message 310, as discussed above. If the authorization message 310 is received, then the process 600 continues in a block 635. Otherwise, the process 600 remains in the block 630.

In the block 635, the authorized portable device 145 determines whether updated instructions are received from the vehicle computer 110. The block 635 is substantially identical to the block 620 of process 600 and therefore will not be repeated to avoid redundancy. If the updated instructions are received, then the process 600 continues in the block 620. Otherwise, the process 600 returns to the block 630.

In the block 640, the authorized portable device 145 generates and provides a response message 315, as discussed above. The response message 315 includes a second user input specifying user authorizations, as discussed above. The process 600 continues in a block 645.

In the block 645, the authorized portable device 145 determines whether a verification message 320 is received from the vehicle computer 110. The authorized portable device 145 can monitor the network 135 to detect the verification message 320, as discussed above. If the verification message 320 is received, then the process 600 continues in a block 650. Otherwise, the process 600 remains in the block 645.

In the block 650, the authorized portable device 145 generates and provides a confirmation message 325, as discussed above. The confirmation message 325 includes a third user input verifying the user data, as discussed above. The process 600 ends following the block 650.

As used herein, the adverb “substantially” means that a shape, structure, measurement, quantity, time, etc. may deviate from an exact described geometry, distance, measurement, quantity, time, etc., because of imperfections in materials, machining, manufacturing, transmission of data, computational speed, etc.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

1. A system, comprising a computer including a processor and a memory, the memory storing instructions executable by the processor to:
upon detecting an authorized portable device, authenticate a user of the portable device for a structure based on then receiving an authentication message from the authorized portable device;
determine a location of the user with respect to the structure;
provide, to the authorized portable device, instructions for the user to provide biometric data based on the location;
upon obtaining the biometric data for the user, generate user data for the user; and
control structure components based on the user data.

2. The system of claim 1, wherein the instructions further include instructions to determine the location based on a user input.

3. The system of claim 1, wherein the instructions further include instructions to determine the location based on a location of the authorized portable device.

4. The system of claim 1, wherein the instructions further include instructions to determine the location based on data from sensors on the structure.

5. The system of claim 1, wherein the instructions further include instructions to obtain the biometric data from a sensor on the structure positioned to face the location.

6. The system of claim 1, wherein the structure is a vehicle, and wherein the instructions further include instructions to operate the vehicle to satisfy an operating parameter specified by the user data.

7. The system of claim 1, further comprising the authorized portable device, wherein the authorized portable device includes a second processor and a second memory, the second memory storing instructions executable by the second processor such that the authorized portable device is programmed to generate the authentication message based on a user input.

8. The system of claim 1, further comprising the authorized portable device, wherein the authorized portable device includes a second processor and a second memory, the second memory storing instructions executable by the second processor such that the authorized portable device is programmed to, upon receiving the instructions, actuate one of a display or a speaker to output the instructions to the user to provide the biometric data.

9. The system of claim 1, wherein the instructions further include instructions to, upon generating the user data, provide, to the authorized portable device, a verification message to verify the user data.

10. The system of claim 9, further comprising the authorized portable device, wherein the authorized portable device includes a second processor and a second memory, the second memory storing instructions executable by the second processor such that the authorized portable device is programmed to, upon receiving a user input verifying the user data, provide a confirmation message to the computer.

11. A method, comprising:
upon detecting an authorized portable device, authenticating, at a computer, a user of the portable device for a structure based on then receiving an authentication message from the authorized portable device;
determining a location of the user with respect to the structure;
providing, to the authorized portable device, instructions for the user to provide biometric data based on the location;
upon obtaining, at the computer, the biometric data for the user, generating user data for the user; and
controlling structure components based on the user data.

12. The method of claim 11, further comprising determining the location based on a user input.

13. The method of claim 11, further comprising determining the location based on a location of the authorized portable device.

14. The method of claim 11, further comprising determining the location based on data from sensors on the structure.

15. The method of claim 11, further comprising obtaining the biometric data from a sensor on the structure positioned to face the location.

16. The method of claim 11, wherein the structure is a vehicle, the method further comprising operating the vehicle to satisfy an operating parameter specified by the user data.

17. The method of claim 11, further comprising generating, at the authorized portable device, the authentication message based on a user input.

18. The method of claim 11, further comprising, upon receiving the instructions, actuating, at the authorized portable device, one of a display or a speaker to output the instructions to the user to provide the biometric data.

19. The method of claim 11, further comprising, upon generating the user data, providing, to the authorized portable device, a verification message to verify the user data.

20. The method of claim 19, further comprising, upon receiving a user input verifying the request, providing, at the authorized portable device, a confirmation message to the computer.
